(19) United States
(12) Patent Application Publication
(10) Pub. No.: US 2006/0075261 A1
(43) Pub. Date: Apr. 6, 2006

(54) Method for enabling services on a fixed image platform

(76) Inventors: Shree A. Dandekar, Round Rock, TX (US); Gaston M. Barajas, Austin, TX (US); James A. Howell JR., Georgetown, TX (US)

Correspondence Address: HAMILTON & TERRILE, LLP, P.O. BOX 203518, AUSTIN, TX, 78720, US

(21) Appl. No.: 10/959,680

(22) Filed: Oct. 5, 2004

(51) Int. Cl. G06F 12/14

(52) U.S. Cl. 713/191

(57) ABSTRACT

A method for enabling services on a fixed image platform which includes installing a fixed image onto an information handling system, installing a key creation utility onto the information handling system, during initial power on of the information handling system executing the key creation utility to create a key, and using the key to activate a service. The information handling system includes a unique system identifier.

### BACKGROUND OF THE INVENTION

1. Field of the Invention

The present invention relates to the field of information handling systems and, more particularly, to enabling services on a fixed image platform.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to manufacture information handling systems based on a build to order process that allows a customer to specify specific hardware and software options. In general, known build to order systems require a large number of disjointed, manual processes that take place for a manufacturer to successfully validate and transform third-party vendor software packages to be factory installable. This not only increases the probability of human-induced error, but dramatically increases the time required to deliver validated, installable software images to the factory environment. It is desirable for an automated system for receiving software and for generating validated, factory-installable software without direct human interaction.

One aspect of factory installable software relates to installing software that requires a key for activation. Certain types of subscription software, such as the MusicMatch subscription software and other subscription products often require such a key. While installing the MusicMatch and other subscription clients on an information handling system, it is desirable to ensure that all the services that are offered at the point of sale (POS) with the subscription client are installed onto the information handling system.

To install these types of services on an information handling system platform, a key creation process is executed during factory install. For example, referring to FIG. 1, labeled prior art, a utility uses a service tag as a unique identifier, along with a collection of other variables to create an encrypted key on the users PC.

However, such a system does not properly install the subscription key on fixed platforms, because the fixed platforms use a master image created from one system that provides copies to the slave systems. Thus, the master system service tag is copied to all slave systems.

A known installation technique uses a unique system identifier to create a customized key for registration validation. For example, the Microsoft operating systems use SMBIOS functions to validate an OEM operating system install versus retail install. Alternately, manual entry of product activation keys provided by a software provider may be used.

### SUMMARY OF THE INVENTION

The present invention enables services on a fixed image platform by providing a key creation utility that is preloaded onto the information handling system, so that the key creation is not performed during factory-install, but post factory-install and pre-customer use. Thus, key creation is manufacturer unique and is created after the fixed image is installed onto the information handling system but before the customer actually uses the information handling system. The customized key creation process enables an information handling system manufacturer to provide a unique customer experience while enabling point of sale and preloading of subscription products.

In one embodiment, the key creation utility is packaged as a separate executable module and is installed separately from the factory install of the client application. During a client installation, the key creation utility is available on the master image. The key creation utility also registers itself within the pre-boot operating system process during the initial power on of the customer installation handling system.

During the factory install process, an image of the key creation utility is made on the master system. No key creation is performed during the factory install; the key is created when the key creation utility is executed when the customer first turns on the purchased information handling system. Before this time, the key creation utility sits dormant on the hard drive of the customer information handling system waiting for the first customer use.

During the initial boot process, the key creation utility is invoked. The key creation utility executes by checking the BIOS of the information handling system, creating an activation key, and removing itself from the customer information handling system. The customer information handling system is essentially left unmodified except for the unique activation key. The entire key creation process occurs during the pre-customer use timeframe and so the risk of exposing the executable module to the user is minimal.

In one embodiment, the invention relates to a method for enabling services on a fixed image platform which includes installing a fixed image onto an information handling system, installing a key creation utility onto the information handling system, during initial power on of the information handling system executing the key creation utility to create a key, and using the key to activate a service. The information handling system includes a unique system identifier.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows an example of a known key creation process.

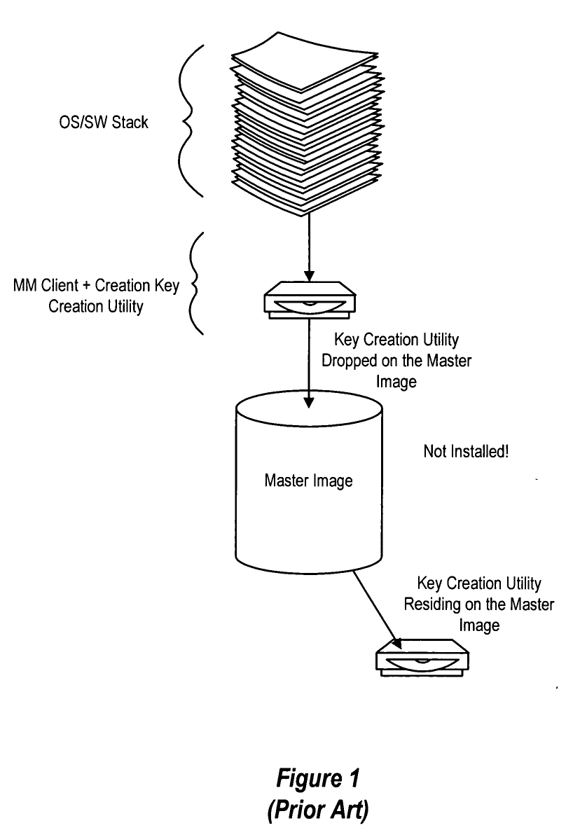

FIG. 2 shows an example of an automated build to order system for installing software on an information handling system.

FIG. 3 is a system block diagram of an information handling system.

FIG. 4 shows a key creation process which is integrated with an automated build to order system for installing software on an information handling system.

### DETAILED DESCRIPTION

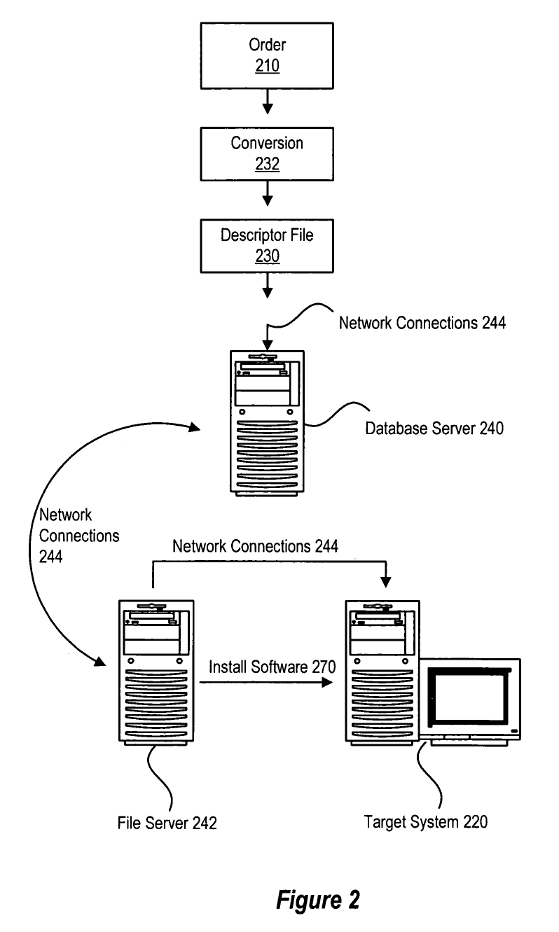

Referring to FIG. 2, a schematic diagram of a software installation system 200 at an information handling system manufacturing site is shown. In operation, an order 210 is placed to purchase a target information handling system 220. The target information handling system 220 to be manufactured contains a plurality of hardware and software components. For instance, target information handling system 220 might include a certain brand of hard drive, a particular type of monitor, a certain brand of processor, and software. The software includes a particular version of an operating system along with all appropriate driver software and other application software along with appropriate software bug fixes. The software also includes ordered subscription software along with an associated key creation utility.

Before target information handling system 120 is shipped to the customer, the plurality of components are installed and tested from, for example, a fixed image of the software. Such software installation and testing advantageously ensures a reliable, working information handling system which is ready to operate when received by a customer.

Because different families of information handling systems and different individual computer components require different software installation, it is necessary to determine which software to install on a target information handling system 220. A descriptor file 230 is provided by converting an order 210, which corresponds to a desired information handling system having desired components, into a computer readable format via conversion module 232.

Component descriptors are computer readable descriptions of the components of target information handling system 220 which components are defined by the order 210. In a preferred embodiment, the component descriptors are included in a descriptor file called a system descriptor record which is a computer readable file containing a listing of the components, both hardware and software, to be installed onto target information handling system 220. Having read the plurality of component descriptors, database server 240 provides a plurality of software components corresponding to the component descriptors to file server 242 over network connection 244. Network connections 244 may be any network connection well-known in the art, such as a local area network, an intranet, or the internet. The information contained in database server 240 is often updated such that the database contains a new factory build environment. The software is then installed on the target information handling system 220. The software installation is controlled by a software installation management server that is operable to control the installation of the operating system and other software packages specified by a customer.

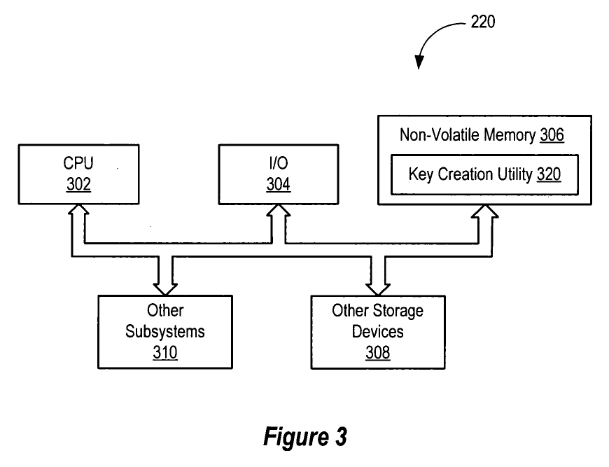

Referring to FIG. 3, a block diagram of an information handling system, such as the target information handling system 220 is shown. The information handling system includes a processor 302, input/output (I/O) devices 304, such as a display, a keyboard, a mouse, and associated controllers, non volatile memory 306 such as a hard disk drive, and other storage devices 308, such as a floppy disk and drive and other memory devices, and various other subsystems 310, all interconnected via one or more buses 312. The software is installed onto the non volatile memory 306. Alternately, the software may be installed onto any appropriate non-volatile memory. The non-volatile memory 306 may also store the key creation utility 320.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

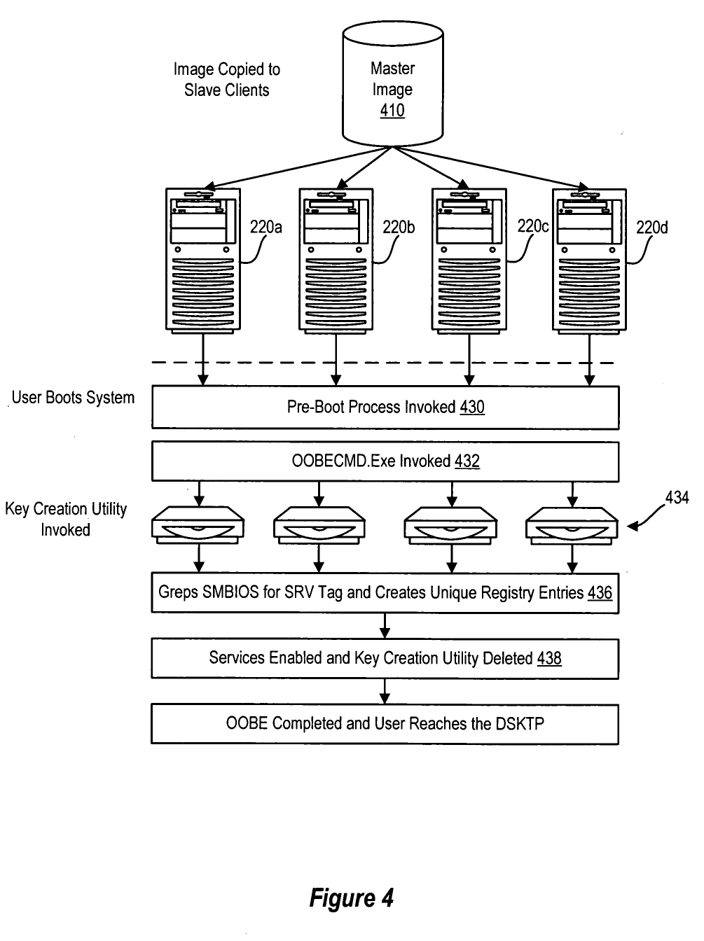

Referring to FIG. 4, a master image of the installed software 410 includes the software fixed image as well as a key creation utility 320. The key creation utility 320 is packaged as a separate executable and is installed separately from the factory install of the client application onto a plurality of target systems 220.

During the client installation, the key creation utility 320 is available on the master image. The key creation utility also registers itself within the pre-boot operating system process during the initial power on of the customer installation handling system.

During the factory install process, an image of the key creation utility is made of the master system. No key creation is performed during the factory install; the key is created when the key creation utility is executed when the customer first turns on the purchased information handling system. Before this time the key creation utility sits dormant on the drive of the customer information handling system waiting for the first customer use.

During the initial boot process, a pre-boot process is invoked at step 430. The pre-boot process includes EBTS (Electronic Break the Seal) for express code activation as well as calling an out of box experience (OOBE) module at step 432. The OOBE module 432 calls the key creation utility at step 434.

The key creation utility executes by checking the BIOS of the information handling system for a service tag which corresponds to the information handling system, creating an activation key, and at step 436. By using the unique key the services corresponding to the customer order are enabled at step 438. The key creation utility 320 then removes itself from the customer information handling system at step 438. The OOBE module completes execution and the presents the user with the desktop display at step 440. The customer information handling system is essentially left unmodified except for the unique activation key. The entire key creation process occurs during the pre-customer use timeframe and so the risk of exposing the executable to the user is minimal.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Consequently, the invention is intended to be limited only by the spirit and scope of the appended claims, giving full cognizance to equivalents in all respects.

Although the present invention has been described in detail, it should be understood that various changes, substitutions and alterations can be made hereto without departing from the spirit and scope of the invention as defined by the appended claims.

What is claimed is:

1. A method for enabling services on a fixed image platform comprising:
installing a fixed image onto an information handling system, the information handling system including a unique system identifier;
installing a key creation utility onto the information handling system;
during initial power on of the information handling system executing the key creation utility to create a key;
using the key to activate a service.

2. The method of claim 1, wherein
the service includes a subscription service.

3. The method of claim 1 wherein
the fixed image includes service software; and
the service software uses the key when activating the service.

4. The method of claim 1 further comprising
installing the fixed image onto a plurality of information handling systems;
installing the key creation utility onto the plurality of information handling systems,
executing the key creation utility on the plurality of information handling systems to create a corresponding plurality of unique keys.

5. The method of claim 1 wherein
the key creation utility executes within of an out of box experience module.

6. The method of claim 1 wherein
the key creation utility deletes itself after creating the key.
